(19) United States
(12) Patent Application Publication
(10) Pub. No.: US 2009/0303190 A1
(43) Pub. Date: Dec. 10, 2009

(54) TOUCH-SENSITIVE DISPLAY DEVICE

(75) Inventor: Hsueh-Yu LU, Tu-Cheng City (TW)

Correspondence Address: Muncy, Geissler, Olds & Lowe, PLLC, P.O. BOX 1364, FAIRFAX, VA, 22038-1364, US

(73) Assignee: Cheng Uei Precision Industry Co., Ltd.

(21) Appl. No.: 12/135,496

(22) Filed: Jun. 9, 2008

(51) Int. Cl. G06F 3/041

(52) U.S. Cl. 345/173

(57) ABSTRACT

A touch-sensitive display device includes a frame assembly, a display module and a touch panel. The frame assembly has a first frame, a second frame received in the first frame and a third frame covered on the first frame. The second frame has a plurality of side walls, two of the side walls adjacent to each other respectively extends upward to form at least one positioning element, a free end of the positioning element is beyond an upper surface of the third frame. The display module is arranged in the frame assembly. The touch panel is arranged on the frame assembly, two sides of the touch panel are restrained by the positioning element. Therefore, the touch panel is located on the frame assembly correctly and easily.

### BACKGROUND OF THE INVENTION

1. Field of the Invention

The present invention relates to a touch-sensitive display device and, more particularly to a touch-sensitive display device convenient for assembly and accurate positioning.

2. The Related Art

Conventionally, an electronic device has a touch-sensitive display device. The touch-sensitive display device includes a frame and a touch panel fixed on the frame by an adhesive. The frame is used to receive a display module.

However, when the touch panel is fixed on the frame by the adhesive, the touch-sensitive display device is subjected to be moved by an undesired force before the adhesive coagulates, as a result, the touch panel will be inaccurately located on the frame.

### SUMMARY OF THE INVENTION

An object of the invention is to provide a touch-sensitive display device including a frame assembly, a display module and a touch panel. The frame assembly has a first frame, a second frame received in said first housing, and a third frame adapted for covering the first frame, the second frame has a plurality of side walls. The display module is received within the frame assembly. The touch panel is arranged on the frame assembly. At least one positioning element extends from each of two adjacent the side walls and can pass through the third frame thereby positioning the touch panel on the frame assembly when the touch panel is mounted on the frame assembly.

As above description, the touch panel is located on the frame assembly correctly by restraining of the positioning element protruded from the second frame. The position method is simple and easy to achieve, and the cost of assembling the touch-sensitive display device is reduced.

### BRIEF DESCRIPTION OF THE DRAWINGS

The invention, together with its objects and the advantages thereof may be best understood by reference to the following description taken in conjunction with the accompanying drawings, in which:

FIG. 1 is an exploded perspective view of a touch-sensitive display device according to the present invention;

FIG. 2 is a perspective view of the touch-sensitive display device before a touch panel is located on a frame assembly; and

FIG. 3 is a perspective view of the touch-sensitive display device.

### DETAILED DESCRIPTION OF THE PREFERRED EMBODIMENT

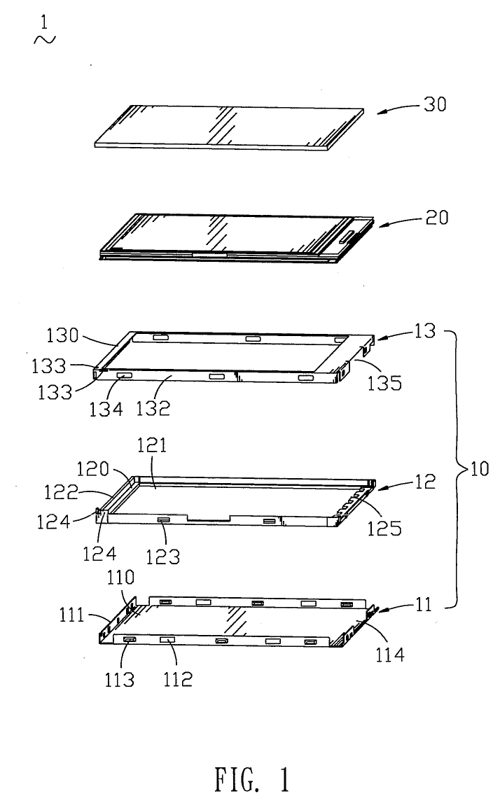

First referring to FIG. 1, an embodiment of a touch-sensitive display device 1 according to the invention is shown. The touch-sensitive display device 1 includes a frame assembly 10, a display module 20 received in the frame assembly 10 and a touch panel 30 fixed on the frame assembly 10. The frame assembly 10 includes a first frame 1, a second frame 12 and a third frame 13.

The first frame 11 has a base 110 showing a rectangular board shape. Four edges of base 110 extend upward to form four side boards 111. The side boards 111 define a plurality of clicking slots 112 and protrude outwardly to form a plurality clicking lumps 113. One of the side boards 111 defines a lower opening 114 at the middle thereof.

The second frame 12 is made of plastic material and is adapted for being received in the first frame 11. The second frame 12 has four side rims 120 with horizontal disposition which define a first rectangular space 121. Each of the side rims 120 extends upwardly to form a side wall 122. One of the side rims wall 122 defines an inner opening 125 corresponding to the lower opening 114. A plurality of protrudent lumps 123 protrudes outwardly from side walls 122 to match clicking slots 112 of the first frame 11. Two of the side walls 122 adjacent to each other respectively extend upwardly to form a positioning member, for example, a fixing tenon 124 or a projection. More specifically, the fixing tenons 124 are formed at a corner of the second frame 12 to adjacent to each other.

The third frame 13 has four frame members 130 with horizontal disposition joined together for arranging the touch panel 30 thereon, two of the frame members 130 adjacent each other respectively define an aperture 133 therein for allowing the corresponding fixing tenon 124 passing therethrough. Specifically, apertures 133 are defined at a corner of the third frame 12 to adjacent to each other. The outer sides of frame members 130 extend downward vertically to form four side plates 132. A plurality of fixing grooves 134 is defined in the side plates 132 for engaging with the clicking lumps 113. One of the side plates 132 defines an upper opening 135 corresponding to lower opening 114.

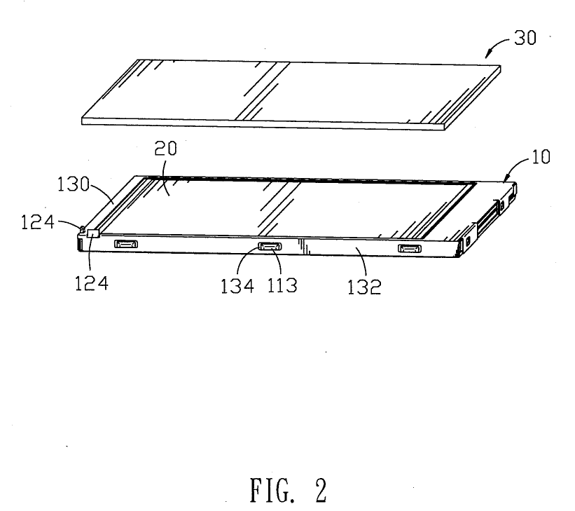

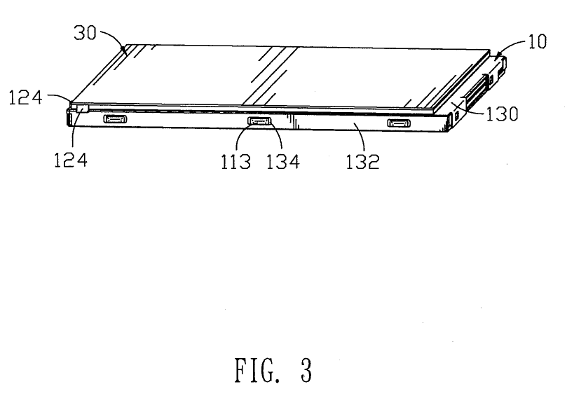

Please refer to FIGS. 1-3, the display module 20 is received in the first rectangular space 121 of the second frame 12, the second frame 12 is fixed in the first frame 11, the third frame 13 covers the first frame 11, and then the touch panel 30 is arranged on the frame assembly 10. The protrudent lumps 123 are locked in the clicking slots 112, so the second frame 12 is fixed in the first frame 11 firmly. When the display module 20 is arranged in the first rectangular space 121 of the second frame 12, the third frame 13 is covered around the first frame 11, the clicking lumps 113 are locked in fixing grooves 134, the fixing tenons 124 pass through the apertures 133, then the touch panel 30 is arranged on the frame assembly 10 and is restrained by the fixing tenons 124, therefore the touch panel 30 is located on the frame assembly 10 accurately. The fixing tenon 124 is lower than a top surface of the touch panel 30 for assembling conveniently. A flexible printed circuit board (FPCB) (not shown) connects the display module 20 and the touch panel 30 to a motherboard (not shown) via the lower opening 114, the inner opening 125, and the upper opening 135.

As above description, the touch panel 30 is located on the frame assembly 10 correctly by restraining of the fixing tenons 124 protruded from the second frame 12, the position method is simple and easy to achieve, and the cost of assembling the touch-sensitive display device 1 is reduced.

An embodiment of the present invention has been discussed in detail. However, this embodiment is merely a specific example for clarifying the technical contents of the present invention that is not to be construed in a restricted sense as limited to this specific example. Thus, the spirit and scope of the present invention are limited only by the appended claims.

What is claimed is:

1. A touch-sensitive display device, comprising:
a frame assembly having a first frame, a second frame received in said first frame and a third frame adapted for covering said first frame, said second frame having a plurality of side walls;
a display module received within said frame assembly; and
a touch panel arranged on the frame assembly;
wherein at least one positioning element extends from each of two adjacent said side walls and can pass through said third frame thereby positioning said touch panel on said frame assembly when said touch panel is mounted on said frame assembly.

2. The touch-sensitive display device as set forth in claim 1, wherein said third frame comprises a plurality of side walls, and at least one aperture is defined through said each of two adjacent said side walls allowing said positioning element to pass through.

3. The touch-sensitive display device as set forth in claim 2, wherein the first frame has a base showing a rectangular board shape, the edges of the base extend upward to form a plurality of side boards enclosing the corresponding side walls of the second frame, outer sides of the frame members extend downward to form a plurality of side plates enclosing the corresponding side boards of the first frame.

4. The touch-sensitive display device as set forth in claim 1, wherein said positioning element is configured to be lower than a top surface of said touch panel.

5. The touch-sensitive display device as set forth in claim 1, wherein said second frame comprises a plurality of side rims extending inwardly from bottoms of said each side walls to define a first rectangular space to receive said display module.

6. The touch-sensitive display device as set forth in claim 1, wherein said positioning element is formed at a corner of second frame for restraining a corner of said touch panel.

7. A touch-sensitive display device, comprising:
a frame assembly comprising a first frame, a second frame and a third frame, wherein said first frame is configured to receive said second frame and said third frame is configured to cover both frames after said second frame is received in said first frame, each said frame having a plurality of side walls;
a display module for receiving within said frame assembly; and
a touch panel adapted for mounting on said frame assembly;
wherein positioning members extending from said frame assembly, configured to restrain at least one corner of said touch panel thereby achieving a relatively accurate positioning of said touch panel on said frame assembly.

8. The touch-sensitive display device as recited in claim 7, wherein said positioning members comprises at least one projection extending from each of at least two adjacent said side walls of said second frame, and at least one opening is defined through each of at least two adjacent said walls of said third frame, allowing said at least one projection to pass through.
